(19) United States
(12) Patent Application Publication
(10) Pub. No.: US 2012/0204801 A1
(43) Pub. Date: Aug. 16, 2012

(54) System and Method of Shrimp Aquaculture Using Floating Feed

(76) Inventors: Addison Lawrence, Port Aransas, TX (US); Tom Zeigler, (US)

(21) Appl. No.: 13/027,011

(22) Filed: Feb. 14, 2011

(51) Int. Cl. A01K 61/02; A01K 61/00

(52) U.S. Cl. 119/207; 119/212

(57) ABSTRACT

According to a first aspect, the disclosure provides a shrimp aquaculture system containing a water container and floating feed for shrimp made of floating feed pellets. More specifically, the water containing may also contain water, such as a fresh water or saline water, including hyper saline water, and shrimp. In certain embodiments, at least 95% of the floating feed pellets may to remain on the surface of water for at least 1 minute after being placed on the water or may have an average specific gravity of between 0.1 and 1.1. According to a second aspect, the disclosure relates to a method of shrimp aquaculture including feeding floating feed to shrimp by placing the floating feed on water, such as fresh water or saline water, containing the shrimp. The floating feed may include at least 5% floating feed pellets.

### TECHNICAL FIELD

The current disclosure relates to a system and method for shrimp aquaculture using a floating feed. In particular embodiments, the system and method may be used in low-water-depth or volume shrimp aquaculture, super intensive raceway production systems, pond production systems, etc. using zero water exchange, recirculating and/or flow through water systems for fresh water (<0.2 ppt) to hyper saline (>100 ppt). The disclosure also relates to floating feed for shrimp.

### BACKGROUND

Shrimp harvesting from the world's oceans can no longer adequately meet demand for shrimp. Accordingly, methods for controlled and enhanced shrimp production or shrimp farming (often referred to as “shrimp aquaculture”) have been developed. The currently predominant methods use ponds for commercial production of shrimp. Other methods use large vessels containing water for production of shrimp. Some such vessels may be fairly deep and may use large volumes of water per amount of shrimp produced. Other, newer methods may employ shallow vessels and may use lower water depths or volumes per amount of shrimp produced.

Regardless of where the shrimp are grown, due the tendency of shrimp to eat what they find in the water, the conventional wisdom is that shrimp must be provided with a feed that sinks so that shrimp may consume it in the water or on the bottom of the pond or vessel in which they are grown. Shrimp do not normally consume food on the water surface in the wild. Prior shrimp aquaculture systems and methods have assumed similar behavior in farmed shrimp. Accordingly, shrimp in aquaculture systems have been provided with non-floating shrimp (aka sinking) feed.

There are several problems associated with non-floating shrimp feed. For example, because the feed rapidly enters the water, it is quickly surrounded by water, which leaches away nutrients, making the feed less nutritious for the shrimp as time passes. Not only is the non-floating shrimp feed often less nutritious, it is also difficult to judge whether the shrimp have eaten all of such feed because it is difficult to see after it enters the water. As a result, shrimp may easily be fed too much feed, leading to waste and water pollution, or too little feed, resulting in less rapid growth. Non-optimal feeding may also occur because non-floating shrimp feed must be spread over the surface of the water by the feeding system, otherwise it will simply sink in one area and not provide food to shrimp in many parts of the pond or vessel. This makes it difficult to use mechanical feeding systems. The inability to use mechanical systems renders it difficult to feed shrimp whenever more food is needed, regardless of the time of day.

Overall, new systems and methods of shrimp aquaculture are needed to address one or more of the above problems as well as other difficulties associated with non-floating shrimp feed.

### SUMMARY

The present disclosure provides a system and method for shrimp aquaculture using floating feed. This system and method may provide one or more advantages over systems using non-floating feed. Many of these advantages may allow more optimal feeding of the shrimp. Various advantages include, but are not limited to:

feeding shrimp using a mechanical point-feeding system;

feeding shrimp whenever needed 24 hours a day;

decreasing water pollution and waste due to unconsumed feed;

optimizing feed rate by observing when feed has been consumed;

increasing shrimp growth rate;

decreasing shrimp death rate;

improving overall shrimp health;

decreasing nutrient leaching from the feed;

decreasing feed loss with the discharge (removal of water) from the production system;

reducing the amount of food required to produce a pound of shrimp, i.e. reducing the FCR (Feed Conversion Ratio).

According to a first aspect, the disclosure provides a shrimp aquaculture system containing a water container and floating feed for shrimp made of floating feed pellets. More specifically, the water vessel may also contain water, such as a fresh water or saline water, including hyper saline water, and shrimp. In another specific embodiment, the water container may include a water vessel having a depth of between 2.5 and 300 cm, or it may be a pond.

In certain embodiments, at least 95% of the floating feed pellets may to remain on the surface of water for at least 1 minute after being placed on the water. The floating feed pellets may alternatively have an average specific gravity of between 0.1 and 1.1 depending upon the salinity of the water. In still other variations, the floating feed pellets may lose less nutrients (e.g. vitamins, minerals, etc.) than a non-floating feed pellet of similar composition within the same length of time (i.e. 5 minutes to 8 hours). The floating feed may contain at least 5% floating feed pellets.

In still other embodiments, the shrimp aquaculture system may include a mechanical feeding system, which may include one or more point-source dispensers. It may also include an automatic controller which causes the mechanical feeding system to dispense a set amount of floating feed at set time intervals. In other embodiments, the system may include a hand feeding system.

In certain embodiments, the aquaculture system may include a water circulation system, such as a zero water exchange system, a recirculating water system, a flow through water system, or any combinations thereof.

According to a second aspect, the disclosure relates to a method of shrimp aquaculture including feeding floating feed to shrimp by placing the floating feed on water, such as fresh water or saline water, containing the shrimp. The floating feed may include at least 5% floating feed pellets.

In specific embodiments, the shrimp may be post-larval shrimp. They may be grown, particularly by repeating the feeding step, until they are a set size, typically a size suitable for a particular purpose. At various points at least a part or portion of the shrimp may be harvested.

In other specific embodiments, at least 95% of the floating feed pellets may remain on the surface of water for at least 1 minute after being placed on the water. In alternative embodiments, the floating feed pellets may have an average specific gravity of between 0.1 and 1.1.

Further embodiments include placing the floating feed on the water in a set amount at a set time interval. The set amount and set time interval are selected to allow continuous or intermittent feeding of the shrimp and may, in more particular embodiments, be selected to optimize shrimp growth, to minimize shrimp death, or to minimize waste of shrimp feed. The set amount or the set time interval may be changed. For example, they may be changed in response to shrimp growth or environmental conditions.

In still another embodiment, the floating feed may be placed on the water using a mechanical feeding system or a hand feeding system. This may be done automatically and may also be done at one or more point sources. The floating feed may be dispersed using a water circulation system such as a zero water exchange system, a recirculating water system, a flow through system, or any combination thereof.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 illustrates a system for shrimp aquaculture using a floating feed according to one embodiment of the present disclosure; and

FIG. 2 illustrates a method for shrimp aquaculture using a floating feed according to one embodiment of the present disclosure.

### DETAILED DESCRIPTION

The current disclosure relates to a system and method of shrimp aquaculture using floating feed. In particular embodiments, the system and method may be used in low-water-depth or volume shrimp aquaculture, super intensive raceway production systems, pond production systems, etc. using zero water exchange, recirculating and/or flow through water systems for fresh water (<0.2 ppt) to hyper saline (>100 ppt). According to one embodiment, the system includes a shrimp containment system, such as a pond or water vessel and floating feed. The system may optionally also include water, shrimp, and a mechanical feed dispenser, such as a point-feeding system. According to another embodiment, the method includes feeding shrimp using floating feed. The method may optionally also include growing the shrimp to a desired size and harvesting the shrimp.

### Floating Feed

The floating feed used in certain systems and methods of the current disclosure may be any feed suitable for feeding shrimp that includes at least 5% floating feed pellets. In general, so long as the specific gravity of the floating feed pellet is less than that of the water it is on, the pellet will float. Thus, a floating feed pellet may have a higher specific gravity (e.g. greater than 1) for water with higher saline content than for water with lower saline content. The floating feed pellet will have density (specific gravity) less than that of sinking feed. In a specific embodiment, a floating feed pellet has a density (i.e. specific gravity) of between 0.1 and 1.1. In contrast, as non-floating (aka sinking) feed is a feed in which than 99% of the pellets settle beneath the surface of water in less than one minute after application to the water. According to one embodiment, the desired feed pellet density may be achieved by controlling the amount of air or void space, nutrient composition (e.g. lipid level), size and surface tension in the feed pellet.

In more specific embodiments, the floating feed pellet may be any feed pellet suitable for feeding shrimp that, when placed on the surface of water, will remain on the water surface for at least one minute before sinking (i.e. becoming substantially beneath the surface of the water). According to a more specific embodiment, a floating feed pellet may remain substantially on the water surface for at least five minutes before sinking More particularly, the floating feed pellet may remain substantially on the water surface at least 15 minutes, even more particularly from between 15 and 240 minutes.

According to a further specific embodiment, at least 10% of a floating feed will remain on the water surface for the time spans indicated above. According to a more specific embodiment, at least 50% of a floating feed will remain on the water surface for the indicated time spans. According to an even more specific embodiment, at lest 90% of a floating feed will remain on the water surface for the indicated time spans.

The floating feed (either in each pellet or in the overall combination of pellets) may contain any components normally found in shrimp feed such as an amino acids or proteins, fatty acids and neutral fat, phospholipids, sterols, vitamins, minerals, etc. In one particular embodiment, it may contain one or more of: animal and/or plant protein, brine shrimp, krill, fish, squid, wheat, corn, grain sorghum, poultry-by-product, egg product, betaine, alanine, isoleucine, leucine, serine, valine, glycine, astaxanthin, vitamin A supplement, vitamin B₁₂ supplement, riboflavin supplement, calcium pantothenate, niacin supplement, vitamin D supplement, vitamin E supplement, menadione, folic acid, biotin, thiamine, pyridoxine hydrochloride, inositol choline chloride, etc.

The floating feed pellets may be produced using methods developed for floating fish food in some embodiments. In one particular embodiment, the floating feed pellets may be made using methods developed for producing shrimp feed, but omitting any steps designed to render the feed pellets non-floating. For example, if the feed pellets are extruded, more air may be allowed to enter the shrimp feed than if it were designed to be non-floating. In other embodiments, the floating feed pellets may be produced by extrusion cooking, stream pelleting, etc. The floating feed in one embodiment may contain a minimum of 5% floating feed pellets and a maximum of 95% sinking feed pellets.

In particular systems and methods of the disclosure, leaching of nutrients from the floating feed may be limited. Nutrient leaching occurs as the feed contacts water and nutrients dissolve into the water. When a feed pellet floats, more of it is exposed to air and less is exposed to water, thereby limiting leaching. According to a particular embodiment, no more than 1% of the surface area of the floating feed pellet may be exposed to water prior to sinking More particularly, no more than 60% of the surface area of the floating feed pellet may be exposed to water prior to sinking According to a different embodiment, no more than 50% of the volume of the floating feed pellet may be saturated with water prior to sinking More particularly, no more than 60% of the volume of the floating feed pellet may be saturated with water prior to sinking According to still another embodiment, no more than 50% of the total nutrients (e.g. vitamins and minerals) in the floating feed may dissolve into the water prior to sinking. More particularly, no more than 50% of the total nutrients (e.g. vitamins and minerals) in the floating feed may dissolve into the water prior to sinking. In particular, the nutrient loss due to leaching from a floating feed pellet may be less than a comparable sinking feed pellet.

### Shrimp Aquaculture System

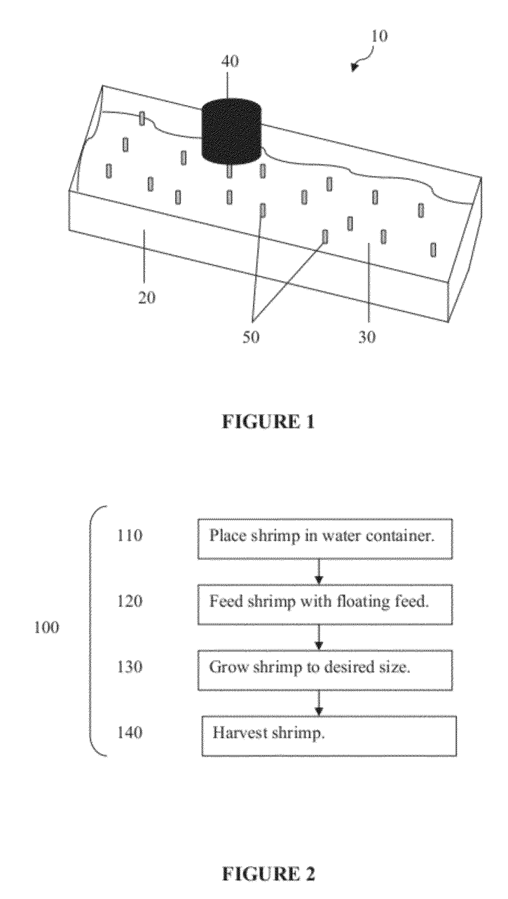

FIG. 1 shows an example shrimp aquaculture system 10. The system may include a water vessel 20 and floating feed 50. The water vessel 20 may be any sort of vessel suitable for growing shrimp. The water vessel may be a culture or production container and may be oval, circular, square, rectangular, etc. shape. For example, it may be part of a low-water-depth or volume aquaculture system. In a particular embodiment (not shown), it may be one or more shallow raceways of the type described in U.S. patent application Ser. No. 12/775,611, titled “System and Method for Super-Intensive Shrimp Production”, incorporated by reference in its entirety herein. In particular the raceway may have a depth of between 2.5 and 300 cm. In this embodiment, the shrimp may be encouraged to consume the floating feed because they are already near the water surface. In another embodiment (not shown), a pond may be used in place of the water vessel.

Water vessel 20 may contain water 30 and shrimp (not shown). Water may be present in an amount sufficient to promote growth and health of the shrimp. Water vessel 20 may also be fitted with other systems and devices related to shrimp growth such as water circulation systems. Water may be fresh water (i.e. <0.2 ppt) to hyper saline water (i.e. >100 ppt).

Floating feed 50 may be any floating feed fed to shrimp as described above. Floating feed 50 may be placed on the surface of water 30. According to one embodiment, floating feed will then remain substantially on the water surface at least one minute. According to a more specific embodiment, the feed may remain at least 5 minutes, more specifically at least 15 minutes, and even more specifically between 15 minutes and 240 minutes.

According to one embodiment, the feed may be placed on the surface of the water at particular time intervals or continuously. If placed at time intervals, these time intervals may be every minute, every 5 minutes, every 15 minutes, every 25 minutes, every 30 minutes or variations thereof.

According to another embodiment, the amount of feed administered may be an amount that will be substantially consumed by the shrimp while the feed is floating. Alternatively, the amount of feed administered may be an amount that will be substantially consumed by the shrimp in the time interval between administrations. In some embodiments, the feed will be substantially all consumed during the time in which it is floating, so the amount determined by either of these factors will be the same. According to other embodiments, at least 5% or, more specifically, at least 90% of the floating feed pellets will be consumed while they are floating. In these embodiments, the remaining feed may be consumed after it has sunk. The amount and timing of feed administration in these embodiments may be such that feed is substantially entirely consumed, whether while floating or after sinking, prior to administration of additional feed. According to another embodiment, the amount of shrimp feed provided and the time interval may be adjusted such that the shrimp are essentially continuously supplied with food, thereby allowing more optimal growth. In a more specific embodiment at least 90%, more particularly at least 95% of the feed may be consumed, thereby reducing waste and water pollution.

Floating feed 50 may be placed on water 30 in any manner currently used in shrimp aquaculture. According to another embodiment, floating feed 50 may be placed on water 30 from one or more point sources. Such point sources may include simply placing the shrimp feed in one or a limited number of locations. In such embodiments, the floating feed may disperse over the surface of water 30 after being placed on water 30. This is in contrast to many current systems using sinking feed in which the feed will not disperse after entering the water and thus must be dispersed as it is placed in the water. Water circulation systems, if present, may assist in dispersal of the floating feed.

As one example of a point-source system, shrimp aquaculture system 10 may further include one or more point-source dispensers 40 (only a single representative dispenser is shown). Point source dispenser may be mounted on or near water vessel 20 in a manner able to allow it to dispense floating feed in one location on the surface of water 30. According to a more particular embodiment, feed dispenser 40 may automatically dispense a pre-set amount of floating feed at a pre-set time interval. The amount of feed dispensed and the time interval may be determined as described above.

Floating feed 50 may also be placed on water 30 using hand dispersion techniques alone or in combination with mechanized techniques.

### Shrimp Aquaculture Method

FIG. 2 illustrates a method of shrimp aquaculture, 100. According to one embodiment, the method may be carried out using the system of FIG. 1, although in other embodiments different systems may be used. Similarly, shrimp aquaculture system 10 may be modified to carry out one or more steps described in connection with method 100, or it may be designed to carry out other methods.

In the initial step 110, shrimp are placed in a water container. According to a more specific embodiment, the shrimp may be post-larval shrimp such as shrimp between five and thirty days old. Alternatively, the shrimp may have an average weight of less than 2.5 g or an average weight of less that 200 g. The shrimp may then be grown to a size suitable for human consumption, bait production, broodstock production, headstarting production or animal feed production using method 100.

In the next step 120, the shrimp are fed floating feed as described above. This step may be repeated at a selected time interval. The amount of feed fed to the shrimp may be a set amount per time interval. For example, the floating feed may be provided at varying time intervals of at least every minute, every five minutes, every 15, minutes, every 25 minutes, or every 30 minutes or continuously. According to another embodiment, the amount of floating feed pellets administered may be an amount that will be substantially consumed by the shrimp while the feed pellets are floating. Alternatively, the feed may be administered in an amount that will be substantially consumed by the shrimp in the time interval between administrations. In one embodiment, the feed will be substantially all consumed during the time in which it is floating, such that the time interval is the same regardless of which of the two above factors is used to determine it.

According to other embodiments, at least 50% or, more specifically, at least 95% of the floating feed pellets will be consumed while they are floating assuming that the shrimp are not feed at a level greater than 110% satiation. In these embodiments, the remaining feed may be consumed after it has sunk. The amount and timing of feed administration in these embodiments may be such that feed is substantially entirely consumed, whether while floating or after sinking, prior to administration of additional feed.

According to another embodiment, the amount of shrimp feed provided and the time interval may be adjusted such that the shrimp are essentially continuously supplied with food. This method may be used to optimize shrimp growth or at least to increase shrimp growth as compared to methods employing non-floating feed. In a more specific embodiment at least 5%, more particularly at least 90% of the feed supplied may be consumed at some point. This method may be used to reduce waste and water pollution.

Particularly when feed is administered in an amount such that it is substantially all consumed prior to the next administration or for feed pellets that float for at least 1 minute, the amount of consumption may be observed by visual or mechanical inspection of the water surface. This visual inspection may be made by an individual responsible for feeding the shrimp manually or for determining feeding settings on an automatic system. If mechanical system is used, the mechanical system may be equipped with a visual detector and may be configured to dispense more floating feed based on a signal from the visual detector. The signal may be triggered by consumption of all or a substantial portion of the shrimp feed.

The amount of feed fed to the shrimp and the intervals at which it is fed may be changed as the shrimp grow and consume more food. These factors may also be adjusted based on shrimp food consumption patterns. For example they may be adjusted based on light levels, temperature, salinity, water quality, etc. Adjustments may be made manually or, for mechanized systems, may occur based on signals from one or more detectors, such as a light detector or thermometer.

If mechanized systems are used, the method may allow the shrimp to be fed at any time, 24-hours a day. In particular they may allow for continuous feeding 24-hours a day.

Feeding the shrimp may be accomplished by placing floating feed on the water surface using current shrimp feeding methods or by dispensing the feed at one or more point sources and allowing it to disperse on the water surface.

Shrimp may be encouraged to eat the floating feed by placing the shrimp in a shallow water container, such as a shallow raceway as described above.

In step 130, the shrimp are grown to a desired size. According to one embodiment, this may be a size suitable for human consumption, broodstock production, bait shrimp production, headstarting, or for use in animal feed. However, it may also be a different size, such as a size suitable for production of bait shrimp, for pond stocking or for broodstock production. Step 130 will, in most embodiments, take place at the same time as step 120, particularly if step 120 is repeated. According to a particular embodiment, the shrimp may grow 15-20% faster as measured by weight increase over time as compared to shrimp fed non-floating feed of similar composition.

Finally, in step 140, the shrimp may be fully or partially harvested. Alternatively, the shrimp may be moved to a different method of shrimp aquaculture.

Methods of the current disclosure may also increase the water quality in shrimp aquaculture by reducing feed waste and resulting pollution. Other methods may increase shrimp health or growth by continuously feeding the shrimp. Still other methods may decrease shrimp death rates. Additionally, because water tends to be discharged from the bottom of water vessels used in shrimp production, methods of the current disclosure may decrease feed loss with the discharge (removal of water) from a production system.

Although only exemplary embodiments of the invention are specifically described above, it will be appreciated that modifications and variations of these examples are possible without departing from the spirit and intended scope of the invention. For example, one of ordinary skill in the art will appreciate that measurements may be varied to some degree without departing from the spirit and scope of the invention. Furthermore, although embodiments in which floating feed is used are described in detail, it will be understood that combination systems and methods in which some floating feed and some non-floating feed are used are possible. The relative and total amounts of floating and non-floating feed and the intervals of their administration may be adjusted to obtain desired results.

1. A shrimp aquaculture system comprising:
a water container; and
floating feed for shrimp, wherein the floating feed comprises floating feed pellets.

2. The shrimp aquaculture system according to claim 1, further comprising water and shrimp in the water container.

3. The shrimp aquaculture system according to claim 1, wherein the water container comprises a water vessel having a depth of between 2.5 and 300 cm.

4. The shrimp aquaculture system according to claim 1, wherein at least 95% of the floating feed pellets are operable to remain on the surface of water for at least 1 minute after being placed on the water.

5. shrimp aquaculture system according to claim 1, wherein the floating feed comprises at least 5% floating feed pellets.

6. The shrimp aquaculture system according to claim 1, wherein the floating feed pellets have an average specific gravity of between 0.1 and 1.1.

7. The shrimp aquaculture system according to claim 1, wherein the floating feed pellet comprises vitamins and minerals and wherein the floating feed pellet is operable to lose less vitamins and minerals than a non-floating feed pellet of similar composition within the same period of time when placed on water.

8. The shrimp aquaculture system according to claim 1, further comprising a mechanical feeding system

9. The shrimp aquaculture system according to claim 8, wherein the mechanical feeding system comprises at least one point-source dispenser.

10. The shrimp aquaculture system according to claim 8, wherein the mechanical feeding system comprises an automatic controller operable to cause the mechanical feeding system to dispense a set amount of floating feed at set time intervals.

11. The shrimp aquaculture system according to claim 1, further comprising a hand feeding system.

12. The shrimp aquaculture system according to claim 2, further comprising fresh water.

13. The shrimp aquaculture system according to claim 2, further comprising saline water.

14. The shrimp aquaculture system according to claim 1, further comprising a water circulation system.

15. The shrimp aquaculture system according to claim 14, wherein the water circulation system comprises a zero water exchange system, a recirculating water system, a flow through water system, or any combinations thereof.

16. A method of shrimp aquaculture comprising feeding floating feed to shrimp by placing the floating feed on water containing the shrimp, wherein the floating feed comprises at least 5% floating feed pellets.

17. The method of shrimp aquaculture according to claim 16, wherein the shrimp comprise post-larval shrimp.

18. The method of shrimp aquaculture according to claim 16, comprising growing the shrimp to a set size.

19. The method of shrimp aquaculture according to claim 18, further comprising repeating the feeding step until the shrimp grow to the set size.

20. The method of shrimp aquaculture according to claim 18, further comprising harvesting at least a part of the shrimp.

21. The method of shrimp aquaculture according to claim 16, wherein at least 95% of the floating feed pellets remain on the surface of water for at least 1 minute after being placed on the water.

22. The method of shrimp aquaculture according to claim 16, wherein the floating feed pellets have an average specific gravity of between 0.1 and 1.1.

23. The method of shrimp aquaculture according to claim 16, further comprising placing the floating feed on the water in a set amount at a set time interval.

24. The method of shrimp aquaculture according to claim 23, wherein the set amount and set time interval are selected to allow continuous or intermittent feeding of the shrimp.

25. The method of shrimp aquaculture according to claim 23, wherein the set amount and set time interval are selected to optimize shrimp growth.

26. The method of shrimp aquaculture according to claim 23, wherein the set amount and set time interval are selected to minimize shrimp death.

27. The method of shrimp aquaculture according to claim 23, wherein the set amount and set time interval are selected to minimize waste of shrimp feed.

28. The method of shrimp aquaculture according to claim 23, further comprising changing the set amount or the set time interval.

29. The method of shrimp aquaculture according to claim 16, further comprising placing the floating feed on the water using a mechanical feeding system.

30. The method of shrimp aquaculture according to claim 29, further comprising placing the floating feed on the water automatically using a mechanical feeding system.

31. The method of shrimp aquaculture according to claim 16, further comprising placing the floating feed on the water at one or more point sources.

32. The method of shrimp aquaculture according to claim 16, further comprising placing the floating feed on the water using a hand feeding system.

33. The method of shrimp aquaculture according to claim 16, further comprising dispersing the floating feed using a water circulation system, wherein the water circulation system comprises a zero water exchange system, a recirculating water system, a flow through system, or any combination thereof.

34. The method of claim 16, wherein the water comprises fresh water.

35. The method of claim 16, wherein the water comprises saline water.
